(19) United States
(12) Patent Application Publication
(10) Pub. No.: US 2005/0061117 A1
(43) Pub. Date: Mar. 24, 2005

(54) Multi-joint wrench

(76) Inventor: Terence Chen, Lo Tung Town (TW)

Correspondence Address: NIKOLAI & MERSEREAU, P.A., 900 SECOND AVENUE SOUTH, SUITE 820, MINNEAPOLIS, MN, 55402, US

(21) Appl. No.: 10/983,409

(22) Filed: Nov. 8, 2004

Related U.S. Application Data
(63) Continuation-in-part of application No. 10/617,522, filed on Jul. 11, 2003.

(30) Foreign Application Priority Data
Oct. 12, 2004 (TW) 93130816
Jun. 25, 2003 (TW) 92117206

(51) Int. Cl. B25B 23/16

(52) U.S. Cl. 81/177.7

(57) ABSTRACT

A wrench includes a head, a first handle and a second handle. The first handle includes first and second ends. The first end of the first handle is pivotally connected with the head. The first handle defines a hole and a recess communicated with the hole. The second handle is pivotally connected with the second end of the first handle. A retaining device includes two detents, a switch and a spring. The detents are movable in the hole between a releasing position and a locking position for locking the head and the second handle in position. The switch is movable in the recess between a releasing position and a locking position for locking the detents in the locking position. The spring is put in the recess for biasing the switch to the locking position.

### CROSS-REFERENCE

The present application is a continuation-in-part application of U.S. patent application Ser. No. 10/617,522.

### BACKGROUND OF INVENTION

1. Field of Invention

The present invention relates to a multi-joint wrench.

2. Related Prior Art

Referring to FIGS. 7 to 9, a conventional wrench includes a head 100, a first handle 200 and a second handle 300. The head 100 includes an ear 110 formed thereon. A plurality of teeth 111 is formed on the ear 110. An aperture 120 is defined in the ear 110. The first handle 200 includes first and second ends. The first handle 200 includes two ears 210 formed at the first end. An aperture 213 is defined in each of the ears 210. A pin 211 is fit in the apertures 213 and 120, thus pivotally connecting the first handle 200 with the head 100. The first handle 200 includes two ears 250 formed at the second end. An aperture 252 is defined in each of the ears 250. The second handle 300 includes an ear 310 formed thereon. A plurality of teeth 311 is formed on the ear 310. An aperture 312 is defined in the ear 310. A pin 320 is fit in the apertures 252 and 312, thus pivotally connecting the second handle 300 with the first handle 200. The first handle 200 includes a longitudinal tunnel 220 defined therein and a transverse tunnel 240 communicated with the longitudinal tunnel 220. A spring 270 and a detent 260 are installed in the longitudinal tunnel 220. The detent 260 includes a plurality of teeth 261 for engagement with the teeth 111. A detent 280 is installed in the longitudinal tunnel 220. The detent 280 includes a plurality of teeth 282 for engagement with the teeth 311. A switch 230, a spring 233 and a fastener 241 are installed in the transverse tunnel 240. The switch 230 includes sections 231, 232 and 234. The section 232 is a socket with a thread formed on an internal face. The fastener 241 includes a thread for engagement with the thread formed on the internal face of the section 232. This conventional wrench can be bent so that it can be used in limited space. However, it cannot be operated in limited and crooked space. It is complicated in structure and troublesome in fabrication for some reasons. Firstly, for abutment against the spring 270, a shoulder must be formed on the wall of the longitudinal tunnel 220. Secondly, for abutment against the spring 233, a shoulder must be formed on the wall of the transverse tunnel 240. Thirdly, for abutment against a head of the fastener 241, a shoulder must be formed on the wall of the transverse tunnel 240. Fourthly, to keep the switch 230 in position, the fastener 241 must be used. Fifthly, to engage the fastener 241 with the section 232, a thread must be formed on the fastener 241 and a thread must be formed on the internal face of the section 232.

The present invention is therefore intended to obviate or at least alleviate the problems encountered in prior art.

### SUMMARY OF INVENTION

A wrench includes a head, a first handle and a second handle. The first handle includes first and second ends. The first end of the first handle is pivotally connected with the head. The first handle defines a hole and a recess communicated with the hole. The second handle is pivotally connected with the second end of the first handle. A retaining device includes two detents, a switch and a spring. The detents are movable in the hole between a releasing position and a locking position for locking the head and the second handle in position. The switch is movable in the recess between a releasing position and a locking position for locking the detents in the locking position. The spring is put in the recess for biasing the switch to the locking position.

The primary advantage of the present invention is to provide a wrench that can be used in limited and crooked space.

Other objects, advantages, and novel features of the invention will become more apparent from the following detailed description when taken in conjunction with the drawings.

### BRIEF DESCRIPTION OF DRAWINGS

The present invention will be described through detailed illustration of the preferred embodiment referring to the drawings.

FIG. 1 is a perspective view of a wrench according to the preferred embodiment of the present invention.

FIG. 2 is an exploded view of the wrench shown in FIG. 1.

FIG. 3 is a cross-sectional partial view of the wrench of FIG. 1.

FIG. 4 is an upper view of the wrench of FIG. 3

FIG. 5 is similar to FIG. 3 but shows a head pivotally connected with a first handle.

FIG. 6 is similar to FIG. 4 but shows the first handle pivotally connected with a second handle.

FIG. 7 is a perspective view of a conventional wrench.

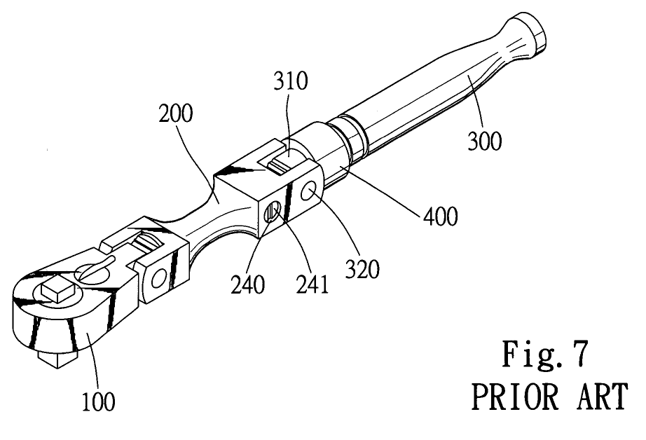

FIG. 8 is an exploded view of the conventional wrench of FIG. 7.

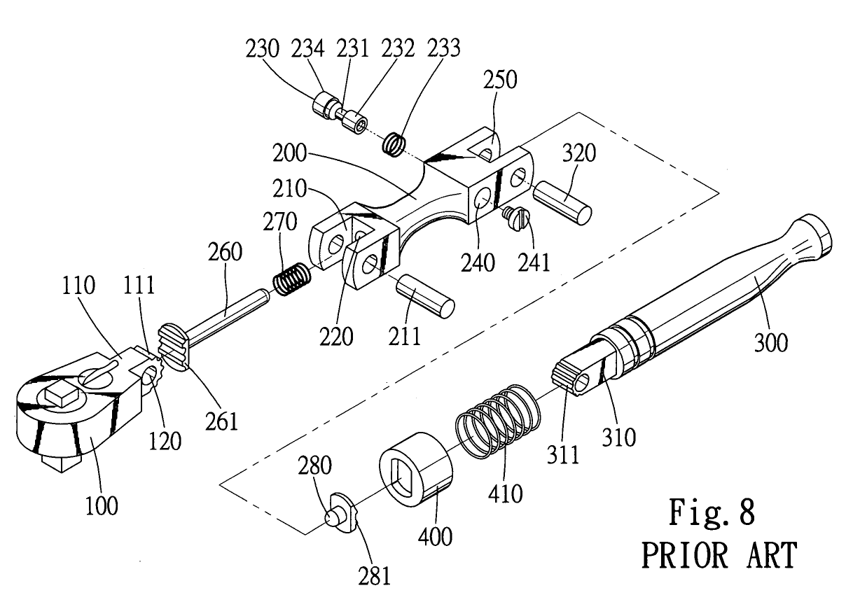

FIG. 9 is a cross-sectional view of the conventional wrench of FIG. 7.

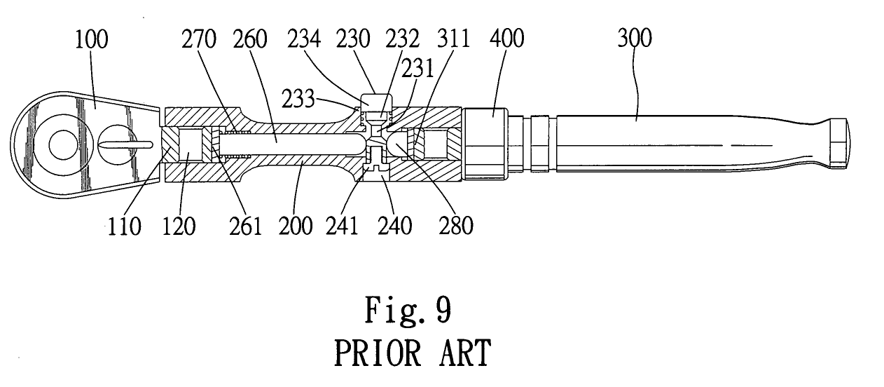

### DETAILED DESCRIPTION OF PREFERRED EMBODIMENT

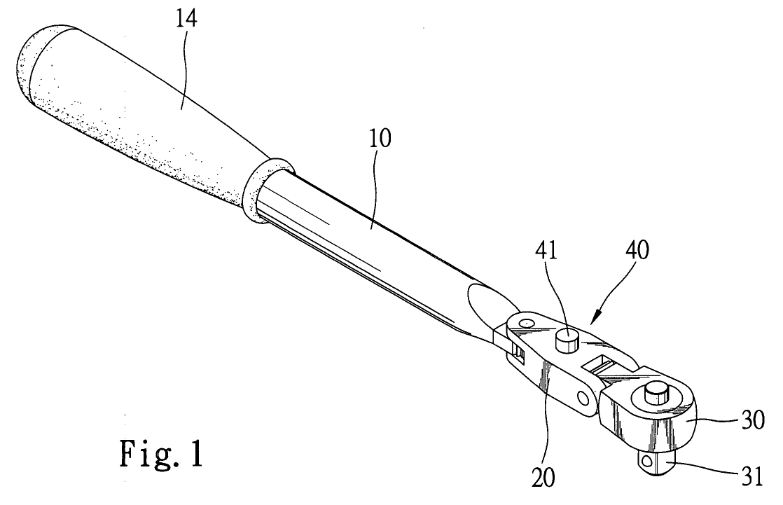

Referring to FIG. 1, according to the preferred embodiment of the present invention, a wrench includes a head 30, a first handle 20 pivotally connected with the head 30 about a first axis and a second handle 10 pivotally connected with the first handle 20 about a second axis. The first and second axes are parallel to each other or not. A retaining device 40 can retain the first handle 20 in position relative to the head 30 and the second handle 10 in position relative to the first handle 20.

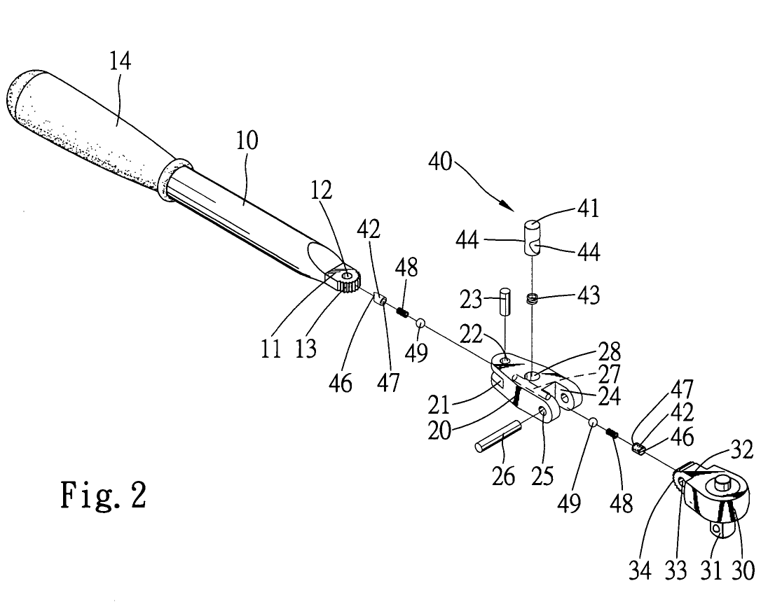

Referring to FIG. 2, the head 30 includes an annular portion to which a square insert 31 is attached. Although not shown for being conventional, a selective one-way driving mechanism is provided between the annular portion and the square insert 31. The square insert 31 can be inserted into a square hole defined in a socket (not shown).

The head 30 includes an ear 32 formed thereon. An aperture 33 is defined in the ear 32. The first handle 20 includes two ears 24 formed at a first end. An aperture 25 is defined in each of the ears 24. A pin 26 is fit in the apertures 25 and 33, thus pivotally connecting the first handle 20 with the head 30.

The first handle 20 includes two ears 21 formed at a second end. An aperture 22 is defined in each of the ears 21. The second handle 10 includes an ear 11 formed at a first end. An aperture 12 is defined in the ear 11. A pin 23 is fit in the apertures 22 and 12, thus pivotally connecting the second handle 10 with the first handle 20. The second handle 10 includes a grip 14 formed at a second end.

The ear 32 includes a plurality of teeth 34 formed thereon. The ear 11 includes a plurality of teeth 13 formed thereon. The retaining device 40 includes first and second detents 42 movably attached to the first handle 20. The first detent 42 can be engaged with the teeth 34 so as to retain the head 30 in position relative to the first handle 20. The second detent 42 can be engaged with the teeth 13 so as to retain the second handle 10 in position relative to the first handle 20.

The first handle 20 includes a detent-receiving hole 27 defined therein. The detent-receiving hole 27 includes two ends each receiving a ball 49, a spring 48 and one of the detents 42. Each of the detents 42 includes a tooth 46 formed at an end for engagement with the teeth 34 or 13 and a recess 47 defined in an opposite end for receiving one of the springs 48. The firs handle 20 defines a recess 28 communicated with the detent-receiving hole 27. A spring 43 is put in the recess 28 before a switch 41. The switch 41 is in the form of a rod. The switch 41 defines two recesses 44 each including an inclined face (not numbered).

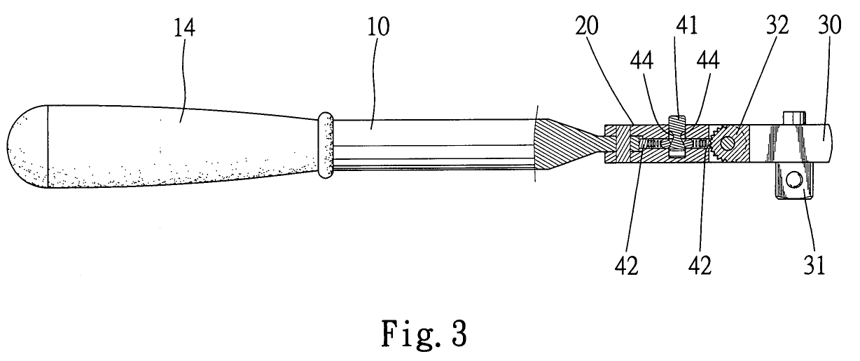

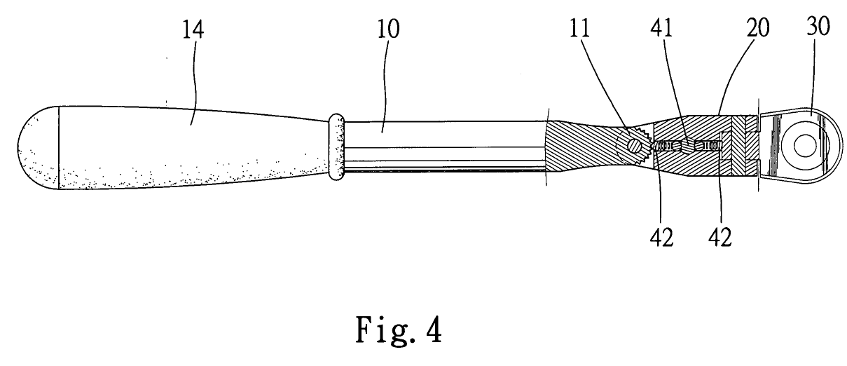

Referring to FIGS. 3 and 4, the wrench is in a locking mode. The spring 43 is compressed between the detent-receiving hole 27 and the switch 41. The switch 41 is biased upward by means of the spring 43. A portion of each of the balls 49 is put in corresponding one of the recesses 44. The remaining portion of each of the balls 49 is pushed toward corresponding one of the detents 42 by means of the inclined face of the corresponding one of the recesses 44. Thus, the balls 49 abut the second ends of the detents 42 through the springs 48. The tooth 46 of the first detent 42 is firmly engaged with the teeth 34 so as to retain the head 30 in position relative to the first handle 20. The tooth 46 of the second detent 42 is firmly engaged with the teeth 13 so as to retain the second handle 10 in position relative to the first handle 20.

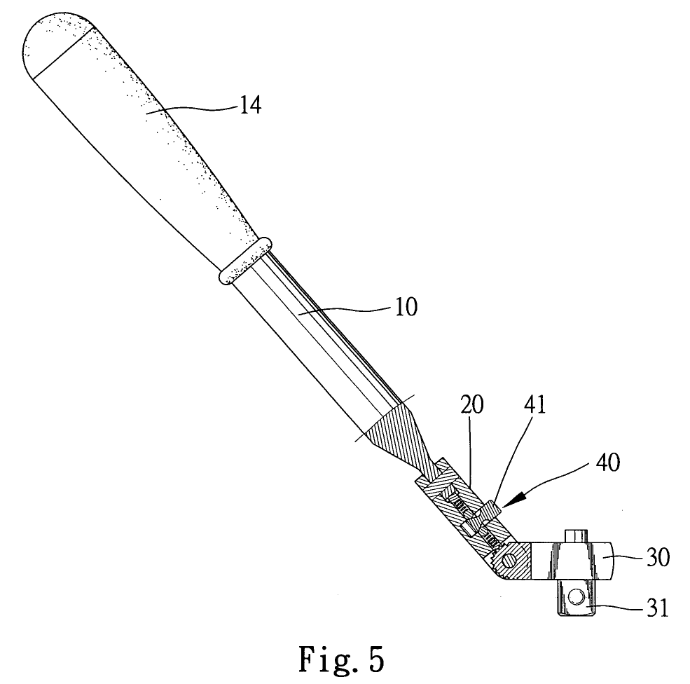

Referring to FIG. 5, when a user pushes down the switch 41, the balls 49 are moved further into the recesses 44. Thus, the first detent 42 can be moved from the ear 32. The tooth 46 of the first detent 42 can be disengaged from the teeth 34 so as to allow pivotal of the head 30 relative to the first handle 20.

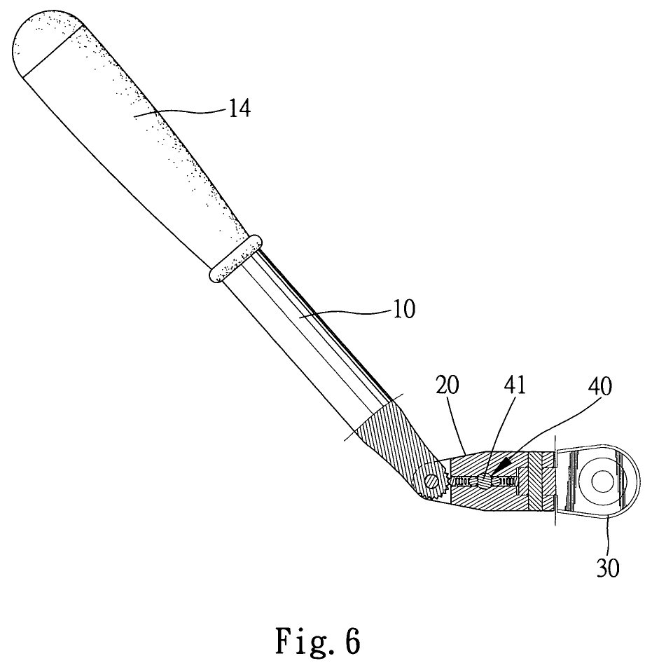

Referring to FIG. 6, when a user pushes down the switch 41, the balls 49 are moved further into the recesses 44. Thus, the second detent 42 can be moved from the ear 1. The tooth 46 of the second detent 42 can be disengaged from the teeth 13 so as to allow pivotal of the second handle 10 relative to the first handle 20.

The present invention has been described through detailed illustration of the preferred embodiment. Those skilled in the art can derive variation from the preferred embodiment without departing from the scope of the present invention. Therefore, the preferred embodiment shall not limit the scope of the present invention defined in the claims.

1. A wrench comprising:
a head;
a first handle comprising first and second ends, the first end of the first handle being pivotally connected with the head about a first axis,
the first handle defining a hole and a recess communicated with the hole;
a second handle pivotally connected with the second end of the first handle about a second axis; and
a retaining device comprising first and second detents movable in the hole between a releasing position and a locking position for locking the head and the second handle in position, a switch movable in the recess between a releasing position and a locking position for locking the detents in the locking position, and a spring put in the recess for biasing the switch to the locking position.

2. The wrench according to claim 1 wherein the first and second axes are parallel to each other.

3. The wrench according to claim 1 wherein the first and second axes are not parallel to each other.

4. The wrench according to claim 1 wherein the head comprises at least one ear formed thereon, wherein the first handle comprises at least one ear formed at the first end for pivotal connection with the ear of the head.

5. The wrench according to claim 4 wherein the first handle comprises two ears formed at the first end, and the head comprises only one ear put between the ears formed at the first end of the first handle.

6. The wrench according to claim 4 comprising a pin, wherein the ear of the head defines an aperture for receiving the pin, wherein the ear formed at the first end of the first handle defines an aperture for receiving the pin.

7. The wrench according to claim 4 wherein the first detent is for engagement with the ear of the head.

8. The wrench according to claim 7 wherein the ear of the head comprises a plurality of teeth for engagement with the first detent.

9. The wrench according to claim 8 wherein the first detent comprises a tooth for engagement with the teeth of the ear of the head.

10. The wrench according to claim 1 comprising a spring compressed between the first detent and the switch.

11. The wrench according to claim 10 comprising a ball provided between the spring and the switch.

12. The wrench according to claim 10 wherein the first detent defines a recess for receiving the spring.

13. The wrench according to claim 1 wherein the switch comprises a recess for receiving a portion of the first detent.

14. The wrench according to claim 1 wherein the first handle comprises at least one ear formed at the second end, wherein the second handle comprises at least one ear formed thereon for pivotal connection with the ear formed at the second end of the first handle.

15. The wrench according to claim 14 wherein the first handle comprises two ears formed at the second cnd, wherein the second handle comprises only one ear put between the ears formed at the second end of the first handle.

16. The wrench according to claim 14 further comprising a pin, wherein the ear formed at the second end of the first handle defines an aperture for receiving the pin, wherein the ear of the second handle defines an aperture for receiving the pin.

17. The wrench according to claim 14 wherein the second detent is for engagement with the ear of the second handle.

18. The wrench according to claim 17 wherein the ear of the second handle comprises a plurality of teeth for engagement with the second detent.

19. The wrench according to claim 18 wherein the second detent comprises a tooth for engagement with the teeth of the ear of the second handle.

20. The wrench according to claim 1 comprising a spring compressed between the second detent and the switch.

21. The wrench according to claim 20 comprising a ball provided between the spring and the switch.

22. The wrench according to claim 20 wherein the second detent defines a recess for receiving the spring.

23. The wrench according to claim 1 wherein the switch comprises a recess for receiving a portion of the second detent.
